(19) United States
(12) Patent Application Publication
(10) Pub. No.: US 2006/0254275 A1
(43) Pub. Date: Nov. 16, 2006

(54) Solar-powered vapor-engine

(76) Inventor: Pierre Kalenzaga, New York, NY (US)

Correspondence Address: PIERRE KALENZAGA, 20 WATERSIDE PLAZA APT: 3F, NEW YORK, NY, 10010, US

(21) Appl. No.: 10/952,577

(22) Filed: May 12, 2005

(51) Int. Cl. F03G 6/06

(52) U.S. Cl. 60/641.15

(57) ABSTRACT

The Solar-Powered Vapor Engine is a machine designed to produce massive and unlimited quantities of hydrogen-fuel, simply and at no cost whatsoever. It consists of a steam engine which is powered, not by burning wood or coal into its furnace as heretofore, but by concentrating thanks to magnifying glasses, the sun-rays on to its furnace. The end-result is: unlimited quantities of hydrogen fuel, which it is thought, is but timely in view of the anticipated and final world-shortage of oil and gasoline some thirty years from now.

This patent application is for the manufacture of a vapor-engine which would work thanks to solar-power.

Description: Whereas in conventional vapor-engines, the fuel used was wood, in this new system the furnace of the vapor-engine would be powered by the sun rays, concentrated through a big magnifying glass or glasses, on to the furnace. The heat thus provided would boil the water in the vapor-engine and so, activate its turbines or pistons.

The temperature of the concentrated sun rays could be regulated if necessary, either: by tilting the magnifying glass(es), by moving it further from, or closer to, the furnace, or by putting a large piece of semi-transparent material (paper or plastic, lightly colored yellow or beige, for instance) over the surface of the magnifying glass(es), etc . . . .

The advantage of this system over previous vapor-engines, is that it does away alltogether with wood-fuel, thereby satisfying the demands of ecologists around the world for cleaner emissions engines.

Industrially, such engines could be used for the production—free of cost—of electricity. And, thanks to that electricity, massive quantities of hydrogen-fuel (also cost-free) could be produced (by electrolysis of water thanks to the electricity), with a view to powering other types of engines, or to powering the same vapor-engines at night so that they could continue producing electricity 24 hours a day, seven days a week without interruption, regardless of the time of day or brief periods of foul weather conditions.

The energy thus produced (totally free of cost, apart from the manufacture of the vapor-engines themselves) is also infinitely renewable, since its production requires only water and sun-rays, both of which are in inexhaustible quantities around the world. In addition, these new vapor-engines use a purely passive energy-producing system: namely the manifying glass(es), the sun rays, and the heavy-duty boilers of the turbines, all of which items are infinitely durable.

Ideally, all the oil-producing/exporting countries, as well as the oil-processing companies in the world, should be fully compensated by an international system, especially set up for this purpose by international bodies or organizations, with a view to fully indemnifying financially these countries or companies, for all economic losses which they may incurr as a result of the launching at the industrial scale, of this new energy producing system.

At the same time, the countries producing other world sources of energy—such as uranium, natural gaz etc . . . , and the companies processing/distributing these other sources of energy, should also be compensated for the same reasons. Furthermore, like their oil-producing/distributing counterparts, they should also be encouraged to stockpile and safe-keep these non renewable sources of energy, for use by the world in emergency situations during which the solar-powered vapor-engines could not be used (such as when the sun is clouded-over for weeks in a row, in the regions where the solar-powered vapor-engines are located).

For this reason, it would be advisable to spread such vapor machine-industrial plants accross the globe, and preferably to locate them in desertic areas, where the yearly rate of sunny days is always at maximum. At the same time, stockpiling the cost-free and mass-produced hydrogen-fuel might provide further relief, in such emergency situations, so as to not exhaust the world's non-renewable sources of energy.

Together with the use of the hydrogen-powered engines by all around the world, such stockpiling of the world's non renewable as well as infinitely-renewable sources of energy, would garantee the world and its inhabitants, perpetually abundant energy for all times to come, regardless of weather conditions.

Huge solar-powered vapor-turbines could thus be established in the deserts or sunny areas of many countries of the world, to mass-produce free electricity and hydrogen-fuel, both for these countries themselves and for the rest of the world.

If world Governments should favor the following option: an international energy-grid (for electricity for instance) could be established all-accross the globe, to mass-produce and share this free electricity between the various countries of the world.

This would be especially useful, given the different world time-zones countries which are going through day-time and thus, are still harnessing the sun's power through these solar-powered vapor-engines, could share this power with their counterparts going currently through night-time.

In the space industry, costly and cumbersome solar panels henceforth become obsolete, as all space vehicles, in Earth orbit or thereabouts, can now be powered with steam engines on board the space-crafts. Furthermore, satellites in orbit, or manned space-craft, can synthesize their own hydrogen fuel while circling the Earth for instance, so that when required, they can use this extra fuel to boost their orbits.

1. I, Pierre Kalenzaga, residing at 20 Waterside Plaza Apartment 3F, claim to be the sole author of the invention herein entitled “Solar-Powered Vapor Engine”, for which a Patent is hereby sought.
